(19) United States
(12) Patent Application Publication
(10) Pub. No.: US 2024/0236363 A1
(43) Pub. Date: Jul. 11, 2024

(54) METHODS AND DECODER FOR VIDEO PROCESSING

(71) Applicant: GUANGDONG OPPO MOBILE TELECOMMUNICATIONS CORP., LTD., Dongguan (CN)

(72) Inventors: Cheolkon JUNG, Dongguan (CN); Qipu QIN, Dongguan (CN)

(73) Assignee: GUANGDONG OPPO MOBILE TELECOMMUNICATIONS CORP., LTD., Dongguan (CN)

(21) Appl. No.: 18/617,538

(22) Filed: Mar. 26, 2024

Related U.S. Application Data
(63) Continuation of application No. PCT/CN2021/121381, filed on Sep. 28, 2021.

(51) Int. Cl. H04N 19/573; H04N 19/105; H04N 19/114; H04N 19/124; H04N 19/139; H04N 19/172; H04N 19/177; H04N 19/42; H04N 19/52; H04N 19/70

(52) U.S. Cl. CPC H04N 19/573; H04N 19/105; H04N 19/114; H04N 19/124; H04N 19/139; H04N 19/172; H04N 19/177; H04N 19/42; H04N 19/52; H04N 19/70

(57) ABSTRACT

Methods and a decoder for video processing are provided. The method includes: a current picture is received; and a group of pictures associated with the current picture is determined. The group of pictures includes a first key picture at a first time prior to the current picture and a second key picture at a second time later than the current picture. The method includes: first and second reference pictures are generated based on the first and second key pictures. Based on the first and second reference pictures bi-directional predictive pictures in the group of pictures are determined. A motion estimation process based on the current picture and the bi-directional predictive pictures is then performed to generate motion information of the current picture.

### CROSS-REFERENCE TO RELATED APPLICATION

This application is a continuation of International Application No. PCT/CN2021/121381 filed on Sep. 28, 2021, the disclosure of which is hereby incorporated by reference in its entirety.

### BACKGROUND

When transmitting images/videos, an encoder can utilize spatial correlation between pixels and temporal correlation between frames/pictures to compress the images/videos and transmit the compressed images/videos in a bitstream. A decoder can then reconstruct the images/videos from the bitstream. Researchers in this field have been committed to exploring a better compromise between a compression rate (e.g., bit-rate, R) and image distortion (D). In the past few decades, a series of image/video coding standards (e.g., JPEG, JPEG 2000, AVC, and HEVC) have been developed. Challenges remain in general compression performance and complexity.

Recent studies of video compression based on deep learning include two major aspects. First, some studies combine deep learning with traditional hybrid video compression. For example, replacing modules of loop filter, motion estimation, and motion compensation with neural networks. Disadvantages of traditional hybrid video compression frameworks include: (1) high complexity and (2) limits of optimization. Consumers' demands for high quality contents (e.g., resolutions 4K, 6K, 8K, etc.) result in remarkable increases of coding/decoding time and algorithm complexity. In addition, traditional hybrid video compression frameworks do not provide “end-to-end” global optimization. Second, some studies include deep learning-based video compression (DVC) framework focus only on 2D videos for compression. These traditional DVC frameworks use a pre-trained optical flow network to estimate motion information, and thus it is impossible to update their model parameters in real time to output optimal motion features. Also, the optical flow network only takes the previous frame as reference, which means that only “uni-directional” motion estimation is performed. Further, these traditional DVC frameworks fail to address data transmission problems from encoders to decoders. In other words, the traditional DVC frameworks require video sequence parameters to be manually provided to the decoder side (otherwise their decoders will not be able to decode videos). Therefore, it is advantageous to have improved methods or systems to address the foregoing issues.

### SUMMARY

The present disclosure relates to video compression schemes, including schemes involving deep omnidirectional video compression (DOVC). More specifically, the present disclosure is directed to systems and methods for providing a DOVC framework for omnidirectional and two-dimensional (2D) videos.

In a first aspect, there is provided a method for video processing, including following operations.

A current picture (xₜ) is received, a group of pictures (GOP) associated with the current picture (xₜ) is determined, the GOP includes a first key picture (xₛ^{I}) and a second key picture (xₑ^{I}), the first key picture is at a first time prior to the current picture (xₜ), and the second key picture is at a second time later than the current picture (xₜ); a first reference picture based on the first key picture (xₛ^{I}) is generated, a second reference picture based on the second key picture (xₑ^{I}) is generated; bi-directional predictive pictures (B/P pictures) in the GOP are determined based on the first reference picture and the second reference picture; and a motion estimation (ME) process is performed based on the current picture (xₜ) and the bi-directional predictive pictures so as to generate motion information (vₜ) of the current picture (xₜ).

In a second aspect, there is provided a method for video processing, including following operations.

A bitstream is parsed to obtain a quantized motion feature (\hat{m}ₜ), the quantized motion feature (\hat{m}ₜ) is determined from motion information (vₜ) of a current picture (xₜ), the motion information (vₜ) is determined based on bi-directional predictive pictures (B/P pictures) in a group of pictures (GOP), the B/P pictures are determined based on first and second reference pictures of the current picture (xₜ), the first reference picture is at a first time prior to the current picture (xₜ), and the second reference picture is at a second time later than the current picture (xₜ); and the quantized motion feature (\hat{m}ₜ) is decoded by an MV decoder to generate a motion information (\hat{v}ₜ).

In a third aspect, there is provided a decoder for video processing, including a processor and a memory.

The memory is configured to store instructions, when executed by the processor, to: parse a bitstream to obtain a quantized motion feature (\hat{m}ₜ), the quantized motion feature (\hat{m}ₜ) is formed from motion information (vₜ) of a current picture (xₜ), the motion information (vₜ) is determined based on bi-directional predictive pictures (B/P pictures) in a group of pictures (GOP), the B/P pictures are determined based on first and second reference pictures of the current picture (xₜ), the first reference picture is at a first time prior to the current picture (xₜ), and the second reference picture is at a second time later than the current picture (xₜ); and decode the quantized motion feature (\hat{m}ₜ) to generate a motion information (\hat{m}ₜ) by an MV decoder.

### BRIEF DESCRIPTION OF THE DRAWINGS

To describe the technical solutions in the implementations of the present disclosure more clearly, the following briefly describes the accompanying drawings. The accompanying drawings show merely some aspects or implementations of the present disclosure, and a person of ordinary skill in the art may still derive other drawings from these accompanying drawings without creative efforts.

FIG. 1 is a schematic diagram illustrating bi-directional prediction rules in accordance with one or more implementations of the present disclosure.

FIG. 2 a schematic diagram illustrating a bi-directional predictive picture compression process in accordance with one or more implementations of the present disclosure.

FIG. 3 is a schematic diagram of a DOVC framework in accordance with one or more implementations of the present disclosure.

FIG. 4 is a schematic diagram illustrating a training stage of the DOVC framework in accordance with one or more implementations of the present disclosure.

FIG. 5 is a flowchart of a method in accordance with one or more implementations of the present disclosure.

FIG. 6 is a schematic diagram illustrating key pictures in accordance with one or more implementations of the present disclosure.

FIG. 7 is schematic diagram of a ME module in the DOVC framework in accordance with one or more implementations of the present disclosure.

FIG. 8 is a schematic diagram illustrating a network structure of a quality enhancement module in accordance with one or more implementations of the present disclosure.

FIG. 9 is a schematic diagram illustrating a DOVC decoder framework in accordance with one or more implementations of the present disclosure.

FIG. 10 is a schematic diagram illustrating data transmission in accordance with one or more implementations of the present disclosure.

FIG. 11 is a flowchart of a method in accordance with one or more implementations of the present disclosure.

FIG. 12 is a schematic diagram of a wireless communication system in accordance with one or more implementations of the present disclosure.

FIG. 13 is a schematic block diagram of a terminal device in accordance with one or more implementations of the present disclosure.

FIGS. 14A and 14B are images illustrating equirectangular projection (ERP) and cubemap projection (CMP) projection formats in accordance with one or more implementations of the present disclosure.

FIG. 15 is a schematic diagram illustrating a selection process of a loss function based on a flag in accordance with one or more implementations of the present disclosure.

FIGS. 16A and 16B are charts showing performance comparison of 360-degree videos projected to CMP and ERP formats.

FIG. 17 includes images illustrating visual comparison among different methods.

FIGS. 18A-E include images illustrating visual comparison among different methods. FIG. 18A shows a raw frame image. FIG. 18B shows a fused offset prediction map (DOVC) image. FIG. 18C shows an optical flow map image.

FIG. 18D shows a bi-directional compensation (DOVC) image. FIG. 18E shows an uni-directional compensation (optical flow) image.

FIG. 19 is a chart illustrating analyses on a quality enhance (QE) module in accordance with one or more implementations of the present disclosure.

### DETAILED DESCRIPTION

To describe the technical solutions in the implementations of the present disclosure more clearly, the following briefly describes the accompanying drawings. The accompanying drawings show merely some aspects or implementations of the present disclosure, and a person of ordinary skill in the art may still derive other drawings from these accompanying drawings without creative efforts.

The present disclosure is related to systems and methods for deep learning (e.g., by using numerical optimization methods) video compression frameworks, including DOVC frameworks. More specifically, the present disclosure is directed to systems and methods for an “end-to-end” (e.g., delivering complex systems/methods in functional form from beginning to end) DOVC framework for both omnidirectional and 2D videos.

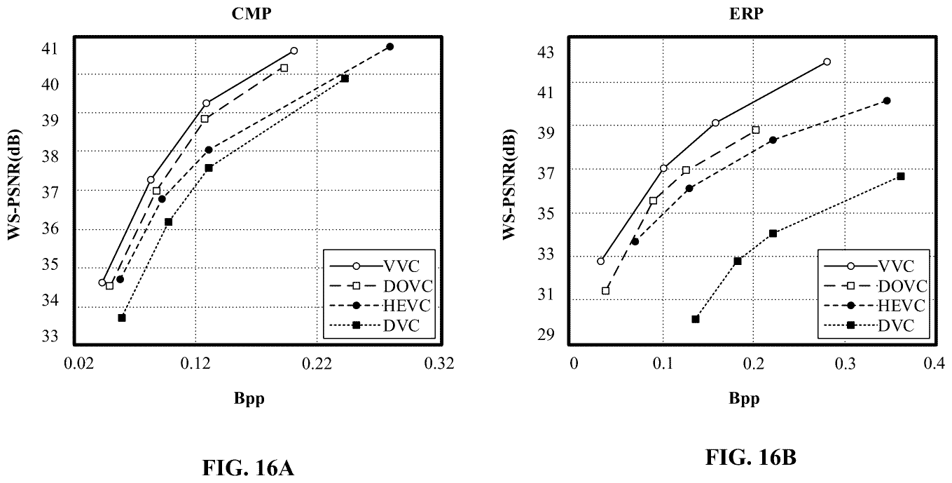

One aspect of the present disclosure includes methods for bi-directional image processing. “Bi-directional” means that the present image processing considers “forward” and “backward” frames (or pictures) in a time domain when predicting a current frame/picture (xₜ). By this arrangement, the present methods can better predict the current picture, compared to conventional “uni-directional” methods (i.e., less time consuming with higher image quality, as shown in test results of FIGS. 16A-19).

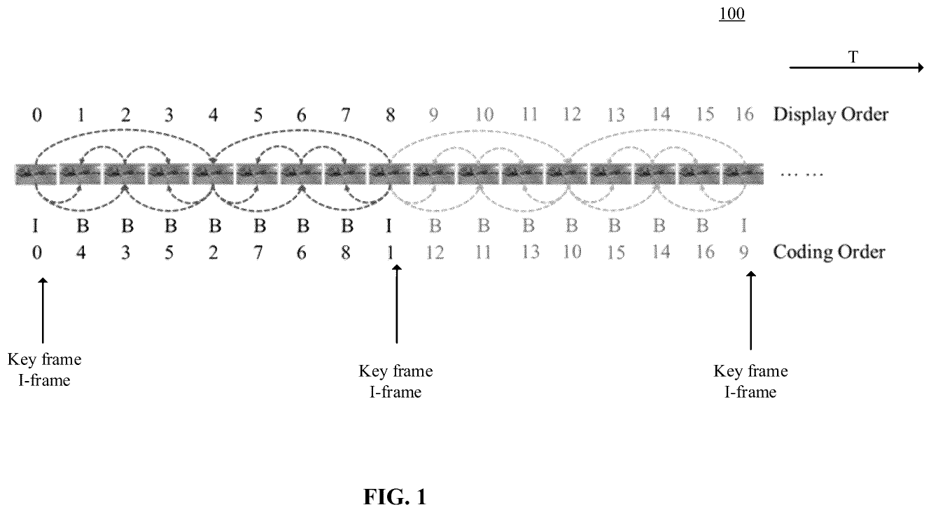

The present methods include, for example, receiving a current picture of a video; and determining an open group of pictures (open GOP) associated with the current picture (xₜ). The open GOP includes a first key picture or “I-picture” (xₛ^{I}) and a second key picture or “I-picture” (xₑ^{I}). The first key picture is at a first time (e.g., a start time, noted as “s”) prior to the current picture (xₜ). The second key picture is at a second time (e.g., an end time, noted as “e”) later than the current picture (xₜ). By this arrangement, the present methods have a “bi-directional” prediction framework (embodiments are discussed in detail with reference to FIGS. 1-3).

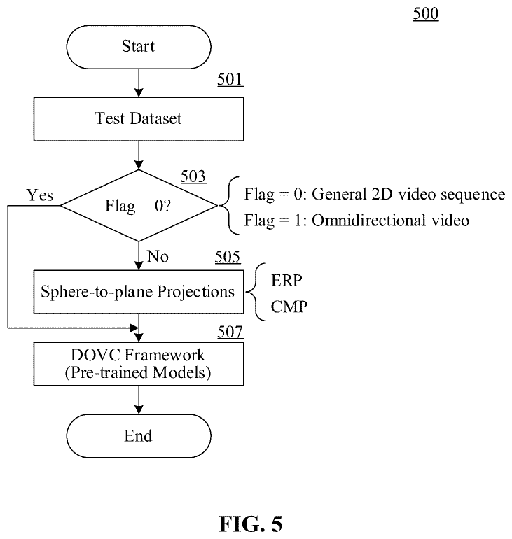

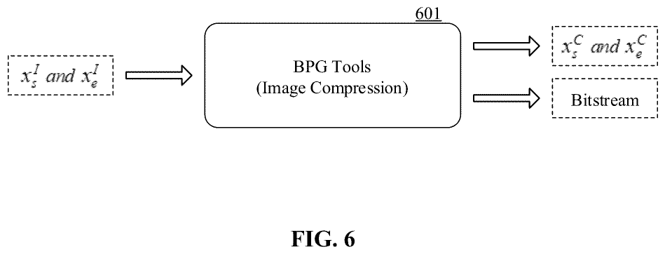

The present methods can further include generating a first reference picture based on the first key picture (xₛ^{I}); and generating a second reference picture based on the second key picture (xₑ^{I}). In some embodiments, the first and second reference pictures can be generated by a better portable graphics (BPG) image compression tool (embodiments are discussed in detail with reference to, e.g., FIG. 6).

The present methods can further include determining bi-directional predictive pictures (B/P pictures) in the GOP based on the first reference picture and the second reference picture; and performing a motion estimation (ME) process based on the current picture (xₜ) and the reference pictures so as to generate motion information (vₜ) of the current picture (xₜ). Embodiments of the bi-directional predictive pictures are discussed in detail with reference to FIGS. 1-3. The motion information (vₜ) can be further processed for predicting the predicted picture (\tilde{x}ₜ) of the current picture.

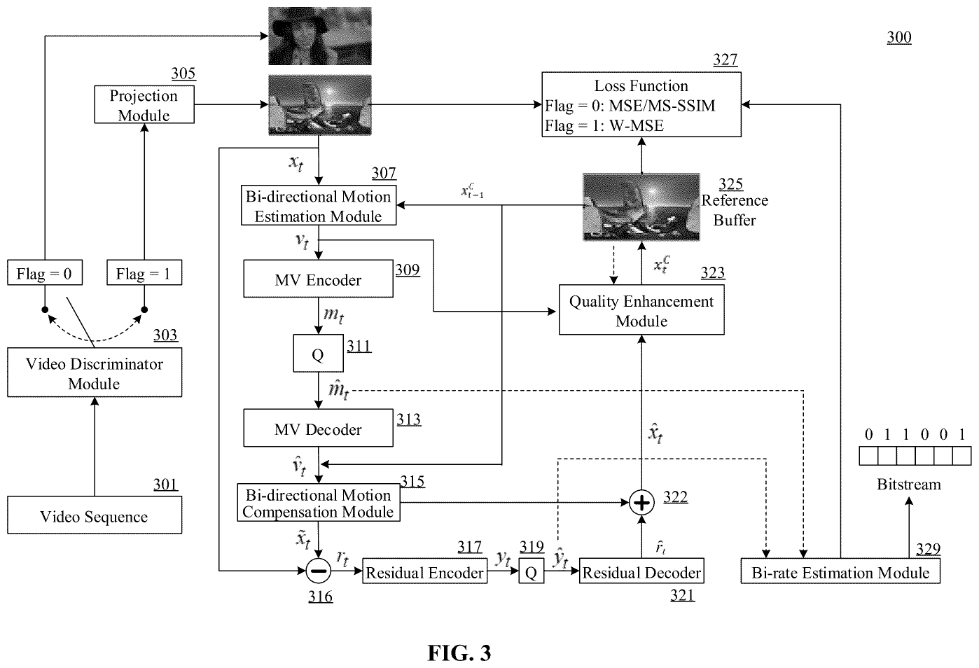

In some embodiments, the present disclosure provides a DOVC framework that can be optimized by deep leaning (e.g., by an object function such as a loss function). In some embodiments, different loss functions can be used, for example, Mean Squared Error (MSE) functions, weighted Mean Squared Error (WMSE) functions, etc. Details of the loss functions are discussed in detail with reference to FIGS. 3, 4, and 15.

One aspect of the present methods and systems is that they are capable of compressing and decompressing a variety of video contents, including regular 2D videos, high dynamic resolution (HDR) videos, and/or omnidirectional videos. Details of processing omnidirectional videos and general 2D videos are discussed in detail with reference to FIGS. 3 and 5.

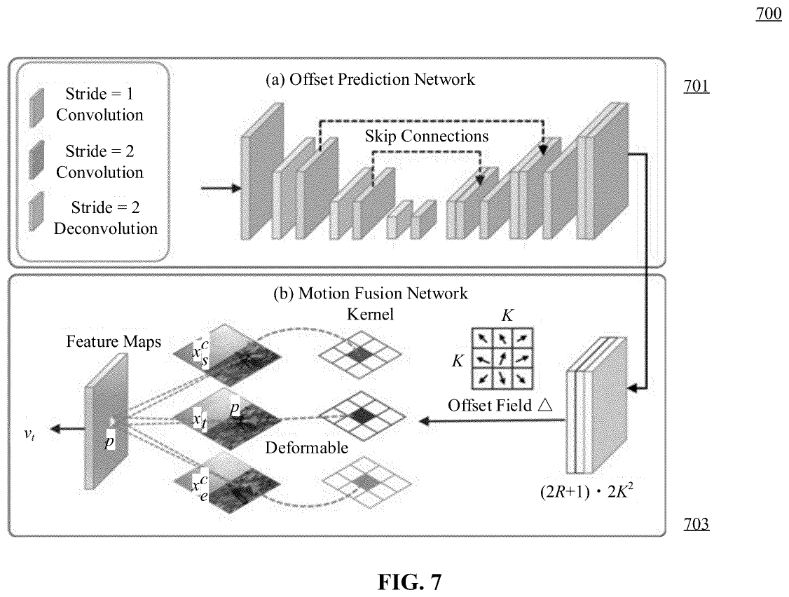

One aspect of the present systems includes bi-directional ME and motion compensation (MC) module (see, e.g., details in FIG. 3). The present ME module includes an offset prediction network based on deformable convolution for bi-directional motion estimation (see, e.g., details in FIG. 7). The offset prediction network utilizes strong temporal correlations between bi-directional, consecutive video frames so to make generated motion information feature map more effective. The bi-directional MC module enables a higher quality prediction picture to be obtained in MC stage, which reduces transmission bits.

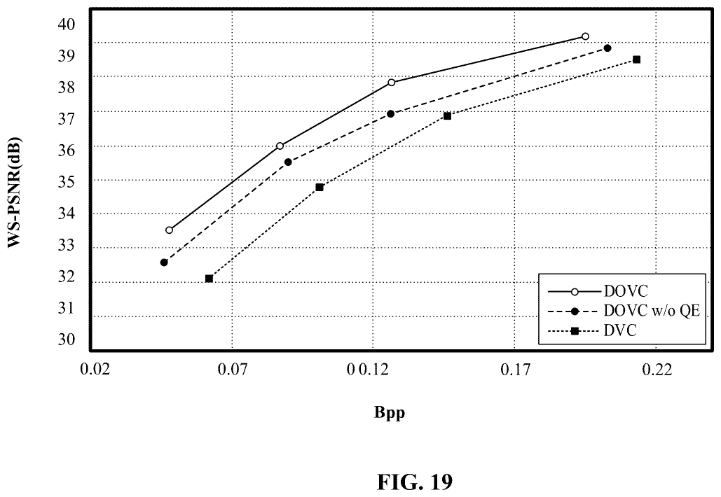

Another aspect of the present disclosure is that it provides a predicted offset field (“Δ” in FIGS. 7 and 8) generated by the ME module. The predicted offset field can be reused to enhance video quality through a quality enhancement (QE) module (FIGS. 3 and 8). The present disclosure provides a simple but efficient QE network capable of achieving satisfactory enhancement results (e.g., FIG. 19).

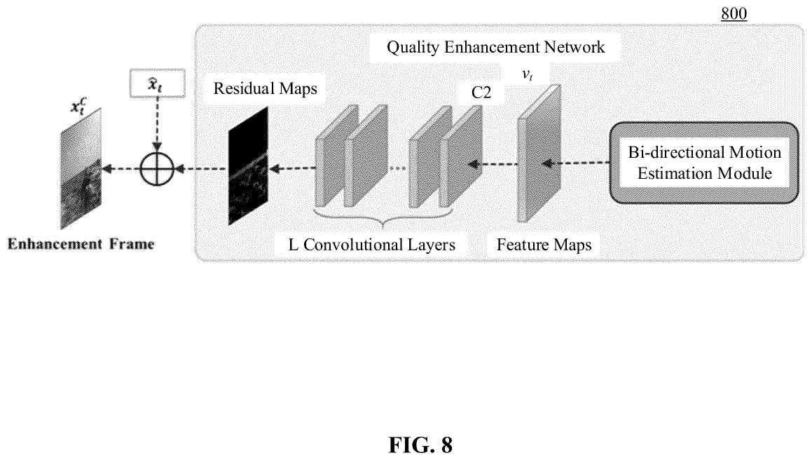

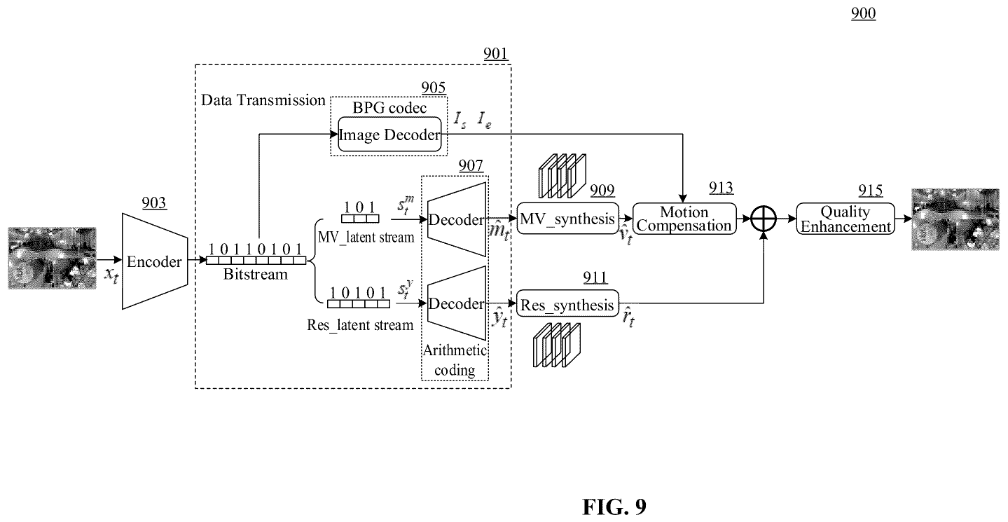

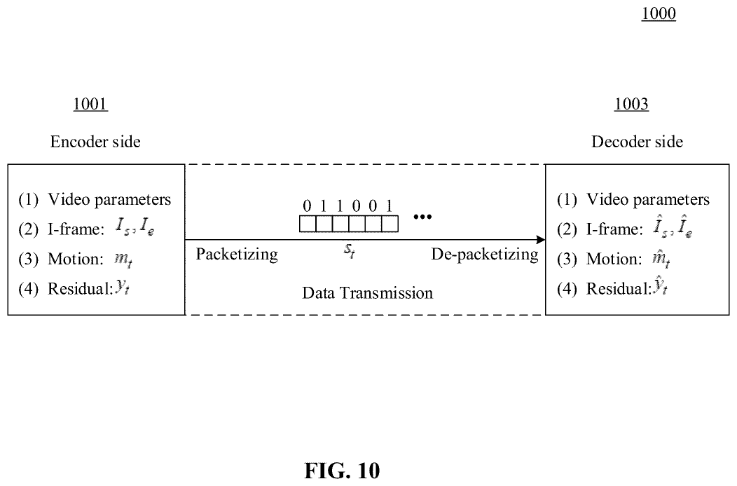

Yet another aspect of the present disclosure is that it provides a pre-trained model on a decoder side to complete decoding tasks, without requiring manually providing video sequence parameters (such as frame size, GOP, and the number of frames) on the decoder side. Details of the decoding capacity of the present system are discussed in detail with reference to FIGS. 9 and 10.

In some embodiments, the present method can be implemented by a tangible, non-transitory, computer-readable medium having processor instructions stored thereon that, when executed by one or more processors, cause the one or more processors to perform one or more aspects/features of the method described herein.

FIG. 1 is a schematic diagram illustrating bi-directional prediction rules in accordance with one or more implementations of the present disclosure. As shown in FIG. 1, a video sequence 100 includes multiple pictures 1-N (only 0-16 are shown) in a time domain T (indicated by “displayer order”). In the illustrated embodiment, the GOP of the video sequence is set as “9.” By this arrangement, pictures 0-8 are in one group, and pictures 8-16 are in another group. In each GOP, there is a start picture xₛ^{I} (e.g., picture 0, picture 8, etc.) and an end picture xₑ^{I} (e.g., picture 8, picture 16, etc.). Both the start and end pictures are key pictures or “I-pictures,” noted by “I.” The remaining pictures (e.g., pictures 1-7, pictures 9-15, etc.) are bi-directional predictive pictures (B/P-pictures), noted by “B.” The bi-directional predictive pictures can be determined based on the key pictures.

For example, picture 4 can be determined based on picture 0 and 8. Picture 2 can be determined based on picture 0 and picture 4, whereas picture 6 can be determined based on picture 4 and picture 8. The rest of the pictures can then be determined by similar approaches. By this arrangement, the “non-key” pictures can be predicted in a “bi-directional” fashion. In some embodiments, the current picture xₜ discussed herein can be one of the pictures to be predicted. The order of coding the foregoing pictures 0-16 is indicated by “coding order” in FIG. 1.

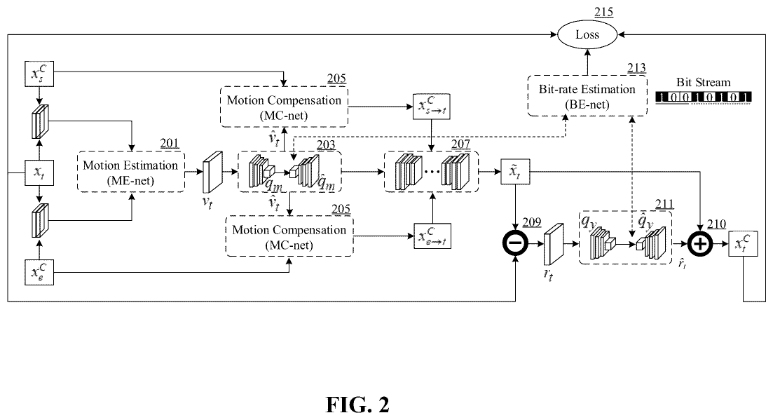

Referring now to FIG. 6, based on the key pictures xₛ^{I} and xₑ^{I}, reference pictures can be generated. In the illustrated embodiments, a better portable graphics (BPG) image compression tool 601 can be used to compress the key pictures to form reconstructed pictures xₛ^{C} and xₑ^{C}, which can be used as reference pictures in further process (e.g., FIG. 2). In some embodiments, other suitable image compression/decompression tool can be used to generate the reference pictures.

FIG. 2 is a schematic diagram illustrating a bi-directional predictive picture compression process in accordance with one or more implementations of the present disclosure. As shown in FIG. 2, the current picture xₜ and the reference pictures xₛ^{C} and xₑ^{C} are combined as an input for an ME module (or ME network) 201. The ME module 201 generates current motion information vₜ. The current motion information is then encoded by a motion vector (MV) encoder/decoder 203 to form a latent motion feature mₜ or qₘ, and then the latent motion feature mₜ or qₘ is quantized to obtain a quantized motion feature \hat{m}ₜ or \hat{q}ₘ. The quantized motion feature mₜ or qₘ, is then decoded by the MV encoder/decoder 203 to form motion information \hat{v}ₜ.

A motion compensation (MC) module 205 utilizes a bi-directional motion compensation process 207 to form a predicted picture \tilde{x}ₜ according to the motion information \hat{v}ₜ and the aforementioned reference pictures (e.g., reconstructed pictures xₛ^{C} and xₑ^{C}).

At a substractor 209, the difference between the predicted picture \tilde{x}ₜ and the current picture xₜ is calculated. The difference is defined as current residual information rₜ. The current residual information rₜ is then encoded (by a residual encoder/decoder 211) to generate a latent residual feature yₜ or q_{y}. Then latent residual feature yₜ or q_{y} is quantized to obtain a quantized residual feature ŷₜ or \hat{q}_{y}. The quantized residual feature ŷₜ or \hat{q}_{y} is then decoded to get residual information \hat{r}ₜ. The prediction picture xₜ and the residual information \hat{r}ₜ are added (at an adder 210) to obtain a reconstructed picture xₜ^{C}.

To repeat the foregoing bi-directional process for the whole video sequence, the reconstructed pictures xₛ^{C} and xₜ^{C} can be used as reference pictures, and then set the next picture “

$$t = \frac{s + t}{2} .$$

” In some embodiment, similarly, the reconstructed pictures xₑ^{C} and xₜ^{C} can be used as reference pictures, and then set the next picture “

$$t = \frac{e + t}{2} .$$

”

In some embodiments, a bit-rate estimation module 213 can be used to determine a bit rate (R) for the encoder/decoder 203 and the residual encoder/decoder 211. The bit rate R can also be used to optimize the present DOVC framework by providing it as an input to a loss function module 215. The loss function module 215 can improve the present DOVC framework by optimizing a loss function such as “λD+R,” wherein “D” is a distortion parameter, “λ” is a Lagrangian coefficient, and R is the bit rate.

FIG. 3 is a schematic diagram of a DOVC framework 300 in accordance with one or more implementations of the present disclosure. The DOVC framework 300 includes a video discriminator module 303 to receive a video sequence 301. The video discriminator module 303 is also configured to determine if the video sequence 301 includes an omnidirectional video sequence. If so, the video discriminator module 303 is configured to set a “flag” so as to identify the type of the video sequence. For example, if the flag is set as “0,” it indicates there is only 2D images in the video sequence 301. If the flag is set as “1,” it indicates there is an omnidirectional video therein. A projection module 305 is configured to process the omnidirectional video by projecting the omnidirectional video to plane images. Embodiments of a sphere-to-plane projection process 500 are discussed in detail with reference to FIG. 5. Further, according to the value of the flag, different loss function can be selected. Embodiments of the selection of the loss function are discussed in detail with reference to FIG. 15.

Referring now to FIG. 5, the process 500 starts by examining or testing a dataset (e.g., the video sequence 301), at block 501. The process 500 continues to decision block 503 to determine if the data dataset includes a flag. The flag “0” indicates the dataset includes/is a general 2D video sequence, and the flag “1” indicates the dataset is/includes an omnidirectional video sequence. If the flag indicates “0,” the process 500 moves to block 507 to provide feedback to a pre-trained DOVC framework for future training. If the flag indicates “1,” the process 500 moves to block 505 to perform a sphere-to-plane projection on the data dataset. The sphere-to-plane projection can be an equirectangular projection (ERP) or a cube-map projection (CMP). Once complete, the projected dataset can be further processed (referring back to FIG. 3) and the process 500 can further move to block 507 to provide feedback to the pre-trained DOVC framework for future training.

Referring back to FIG. 3, the DOVC framework 300 also includes a loss function module 327 for future training. Processing/results of the video discriminator module 303 and the projection module 305 can be transmitted to the loss function module 327. Different loss functions can be used for different flag indications. For example, when the flag indicates “0,” Mean Squared Error (MSE) functions or Multi-scale Structural Similarity (MS-SSIM) functions can be used. When the flag indicates “1,” weighted Mean Squared Error (WMSE) function can be used.

After the video sequence 301 is examined and/or processed (e.g., projected), current picture xₜ and reference (or reconstructed) pictures from previous picture \hat{x}ₜ₋₁ (from a reference buffer 325) can be combined as input for a bi-directional ME module 307. The bi-directional ME module 307 generates current motion information vₜ. The current motion information is then encoded by a motion vector (MV) encoder 309 to form a latent motion feature mₜ, and then the latent motion feature mₜ is quantized by a quantization module 311 to obtain a quantized motion feature \hat{m}ₜ. The quantized motion feature \hat{m}ₜ is then decoded by the MV decoder 313 to form predicted motion information \hat{v}ₜ.

The predicted motion information \hat{v}ₜ is then directed to a bi-directional; motion compensation (MC) module 315 to form a predicted picture \tilde{x}ₜ. The predicted picture \tilde{x}ₜ is further directed to a substractor 316, where the difference between the predicted picture \tilde{x}ₜ and the current picture xₜ is calculated. The difference is defined as current residual information rₜ.

The current residual information rₜ is then encoded (by a residual encoder 317) to generate a latent residual feature yₜ. Then latent residual feature yₜ is quantized (by a quantization module 319) to obtain a quantized residual feature ŷₜ. The quantized residual feature ŷₜ is then decoded (by a residual decoder 321) to get predicted residual information \hat{r}ₜ. The prediction picture \tilde{x}ₜ and the prediction residual information \hat{r}ₜ are directed to an adder 322 to obtain a reconstructed picture \hat{x}ₜ. The reconstructed picture \hat{x}ₜ. can be used as future reference pictures and stored in the reference buffer 325.

In some embodiments, the reconstructed picture \hat{x}ₜ can be directed to a quality enhancement (QE) module 323 for quality enhancement. The QE module 323 performs a convolutional process so as to enhance the image quality of the reconstructed pictures and obtain xₜ^{C} with higher quality. Embodiments of the QE module 323 are discussed in detail with reference to FIG. 8 below.

The DOVC framework 300 can include a bit-rate estimation module 329 configured to determine a bit rate (R) for the MV encoder/decoder 309, 313 and the residual encoder/decoder 317, 321. The bit rate R can also be used to optimize the present DOVC framework 300 by providing it as an input to the loss function module 327. The loss function module 327 can improve the present DOVC framework 300 by optimizing a loss function.

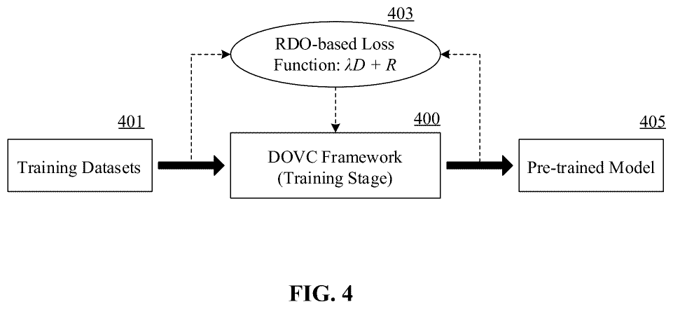

FIG. 4 is a schematic diagram illustrating a training stage of a DOVC framework 400 in accordance with one or more implementations of the present disclosure. The DOVC framework 400 can be trained by inputting training datasets 401 into a rate distortion optimization (RDO)-based loss function 403. The training result can be directed to and improve a pre-trained model 405. By this arrangement, the DOVC framework 400 can be trained and improved.

FIG. 7 is schematic diagram of a ME module 700 in the DOVC framework in accordance with one or more implementations of the present disclosure. The ME module 700 includes an offset prediction module 701 and a deformable convolution module 703. The offset prediction module 701 is configured to implement a bi-directional offset prediction. The offset prediction module 701 takes three pictures (i.e., two reference pictures and a current picture) and then calculates offset values δ in an enlarged picture K² (i.e., “K×K”). The offset values δ can be added up as “(2R+1) 2K²” (wherein “2R” indicates the two reference pictures and “1” indicates the current picture). The offset values δ can then be processed in an offset field Δ (e.g., where an offset being detected and to be predicted) of the pictures. By using the enlarged picture K², the offset prediction module 701 can have a “U-shaped” picture structure (e.g., the reference pictures on both sides are larger, whereas the current picture in the middle is smaller). By this arrangement, the offset prediction module 701 can capture large temporal dynamics of an offset, and thus enhances its offset prediction qualities.

The deformable convolution module 703 is configured to fuse temporal-spatial information to generate motion information vₜ. Output features (e.g., the offset values δ and the offset field Δ) form the offset prediction module 701 are fed into the deformable convolution module 703 as an input. The deformable convolution module 703 then performs a convolutional process by using multiple convolutional layers with different parameters (e.g., stride, kernel, etc.). As shown in FIG. 7, a feature map can be generated based on the results of the convolutional process for the current picture xₜ and the reference pictures xₛ^{C} and xₑ^{C}. The feature map can be further processed by a QE module (FIG. 8).

Advantages of the ME module 700 include that it takes consecutive pictures together as an input so as to jointly consider and predict all deformable offsets at once (as compared to conventional optical flow methods that only handle one reference-target picture pair at a time).

In addition, the ME module 700 uses pictures with a symmetric structure (e.g., the “U-shaped” structure; e.g., referring to that the ME module 700 performs downsampling and then upsampling). Since consecutive pictures are highly correlated, offset prediction for the current picture can be benefited from the other adjacent pictures, which more effectively use temporal information of the frame, compared to conventional “pair-based” methods. Also, joint prediction is more computationally efficient at least because all deformable offsets can be obtained in a single process.

FIG. 8 is a schematic diagram illustrating a network structure 800 in accordance with one or more implementations of the present disclosure. In addition to the offset prediction module 701 and the deformable convolution module 703 discussed in FIG. 7, the network structure 800 includes a quality enhancement (QE) module 801 configured to further enhance the image quality. Using the feature map from the deformable convolution module 703 as an input, the QE module 801 can perform a convolutional process and generate a residual map. The residual map and a target (or reconstructed) picture \hat{x}ₜ can be combined so as to form an enhanced target picture xₜ^{C}. The enhanced target picture xₜ^{C} can be stored in a reference buffer (e.g., the reference buffer 325 in FIG. 3) for further processes.

In some embodiments, during the convolutional process performed by the QE module 801, a regular convolutional layer can be set as “stride 1, zero padding” so as to retain feature size. Deconvolutional layers with “stride 2” can be used for down-sampling and up-sampling. Rectified Linear Unit (ReLU) can be adopted as an activation function for all layers except the last layer (which uses linear activation to regress the offset field 4). In some embodiments, a normalization layer is not used.

In some embodiments, the ME module, the MC module, and the QE module can be implemented in accordance with other standards, such as HEVC, VVC, etc., and are not limited to the DOVC framework disclosed herein.

FIG. 9 is a schematic diagram illustrating a system 900 having a DOVC decoder framework 901 in accordance with one or more implementations of the present disclosure. As shown, a current picture xₜ is encoded by an encoder 903 and then transmitted to the DOVC decoder framework 901. For key pictures or I-pictures Iₛ, Iₑ, an image decoder 905 can adopt a BPG tool with BPG codec for image compression and decompression. For bi-directional predictive pictures (B/P pictures), a decoder 907 utilizes a stand-alone version of arithmetic coder (e.g., developed by Mentzer et al.) for inter-picture compression and decompression. The B/P pictures are divided into an MV latent stream sₜ^{m}, and a residual latent stream sₜ^{y}. The decoder 907 respectively generates feature maps \hat{m}ₜ and ŷₜ. The feature maps \hat{m}ₜ and ŷₜ are respectively sent to an MV decoder 909 and a residual decoder 911 and are inversely transformed into motion information \hat{v}ₜ and residual information \hat{r}ₜ. Then a motion compensation (MC) module 913 integrates the I-pictures Iₛ, Iₑ, the motion information \hat{v}ₜ and the residual information \hat{r}ₜ to obtain a current reconstructed picture \hat{x}ₜ. Then a quality enhancement (QE) module 915 can further improve the quality of the reconstructed picture. The DOVC decoder framework 901 has an efficient data transmission scheme, as discussed with reference to FIG. 10 below. In some embodiments, the DOVC decoder framework 901 can be implemented without the QE module 915

FIG. 10 is a schematic diagram illustrating a data transmission scheme 1000 in accordance with one or more implementations of the present disclosure. The data transmission scheme 1000 represents the data transmission of the DOVC decoder framework 901. As shown, both encoder side 1001 and decoder side 1003 have four types of information: (1) video parameters (such as picture size, total number of pictures, GOP, flag, etc.); (2) key pictures; (3) motion information; and (4) residual information. In present methods and systems, these four types of information can be transmitted in one bitstream. In conventional, inefficient schemes, at least two types of information (1) and (2) need to be separately transmitted or manually provided to the decoder side. Therefore, the data transmission scheme 100 is more efficient than conventional ones.

FIG. 11 is a flowchart of a method 1100 in accordance with one or more implementations of the present disclosure. The method 100 can be implemented by a system (such as a system with the DOVC framework 300, including an encoder and a decoder). The method 100 is for bi-directional image processing. The method 1100 includes, at block 1101, receiving a current picture xₜ of a video. At block 1103, the method 1100 continues by determining a group of pictures (GOP) associated with the current picture xₜ. The GOP includes a first key picture xₛ^{I} and a second key picture xₑ^{I}. The first key picture is at a first time prior to the current picture xₜ, and the second key picture is at a second time later than the current picture xₜ.

At block 1105, the method 1100 continues by generating a first reference picture based on the first key picture xₛ^{I} and generating a second reference picture based on the second key picture xₑ^{I}. At block 1107, the method 1100 continues to determine bi-directional predictive pictures (B/P pictures) in the GOP based on the first reference picture and the second reference picture.

At block 1109, the method 1100 continues to perform a motion estimation (ME) process based on the current picture xₜ and the bi-directional predictive pictures so as to generate motion information vₜ of the current picture xₜ.

In some embodiments, the first reference picture can be a first reconstructed picture xₛ^{C} based on the first key picture xₓ^{I} processed by a better portable graphics (BPG) image compression tool. The second reference picture can be a second reconstructed picture xₑ^{C} based on the second key picture xₑ^{I} processed by the BPG image compression tool.

In some embodiments, the method 1100 can further comprise: (i) encoding the motion information vₜ by a motion vector (MV) encoder so as to form a latent motion feature mₜ of the current picture xₜ; (ii) quantizing the latent motion feature mₜ to form a quantized motion feature \hat{m}ₜ; (iii) transmitting the quantized motion feature \hat{m}ₜ in a bitstream; (iv) receiving the quantized motion feature \hat{m}ₜ from the bitstream; (v) decoding the quantized motion feature \hat{m}ₜ to form a predicted motion information \hat{v}ₜ by an MV decoder; and (vi) performing a motion compensation (MC) process based on the motion information \hat{v}ₜ and the bi-directional predictive pictures to form a predicted picture \tilde{x}ₜ.

In some embodiments, the method 1100 can further comprise: (a) determining a current residual information rₜ by comparing the predicted picture \tilde{x}ₜ and the current picture xₜ; (b) encoding the current residual information rₜ by a residual encoder to form a latent residual feature yₜ; (c) quantizing the latent residual feature yₜ to form a quantized residual feature ŷₜ; (d) decoding the quantized residual feature ŷₜ by a residual decoder to form a predicted residual information \hat{r}ₜ; and (e) generating a reconstructed picture \hat{x}ₜ based on the predicted picture \tilde{x}ₜ and the residual information \hat{r}ₜ.

In some embodiments, the method 1100 can further comprise setting the reconstructed picture \hat{x}ₜ as the first reference picture. In some embodiments, the method 1100 can further comprise determining, by a video discriminator module, whether the video includes an omnidirectional video sequence based on a flag. In response to an event that video includes the omnidirectional video sequence, performing a sphere-to-plane projection on the omnidirectional sequence.

In some embodiments, the ME process is performed by an offset prediction network, the offset prediction network is configured to perform an offset prediction based on offset values (δ) of the current picture xₜ, the first reference picture, and the second reference picture. The offset values δ can be used to generate a feature map of the current picture xₜ by a spatiotemporal deformable convolution process. The feature map can used to form a residual map of the current picture xₜ by a quality enhancement module, and wherein the quality enhancement module includes multiple convolutional layers (L), and wherein the quality enhancement module performs a rectified linear unit (ReLU) activation process so as to form the residual map. The residual map is used to enhance a reconstructed picture \hat{x}ₜ generated based on the current picture xₜ.

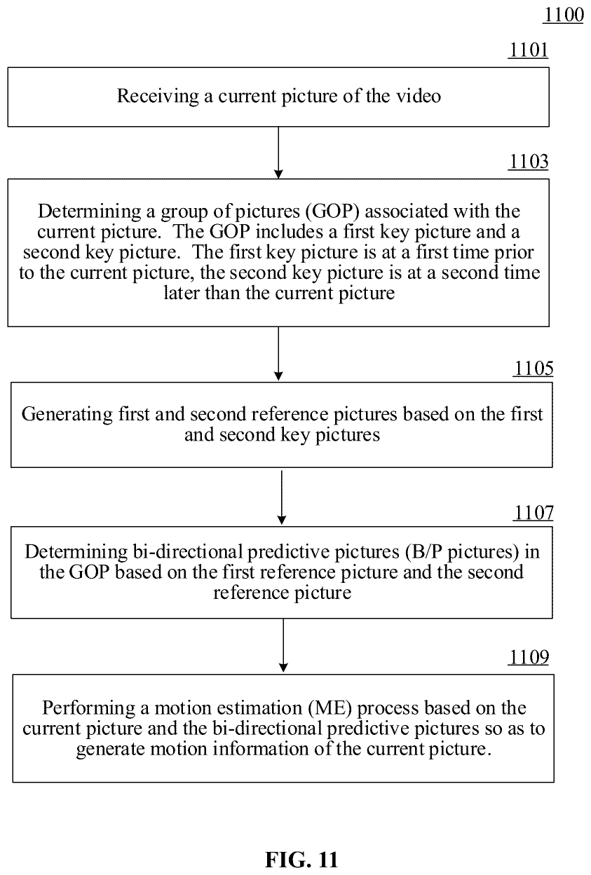

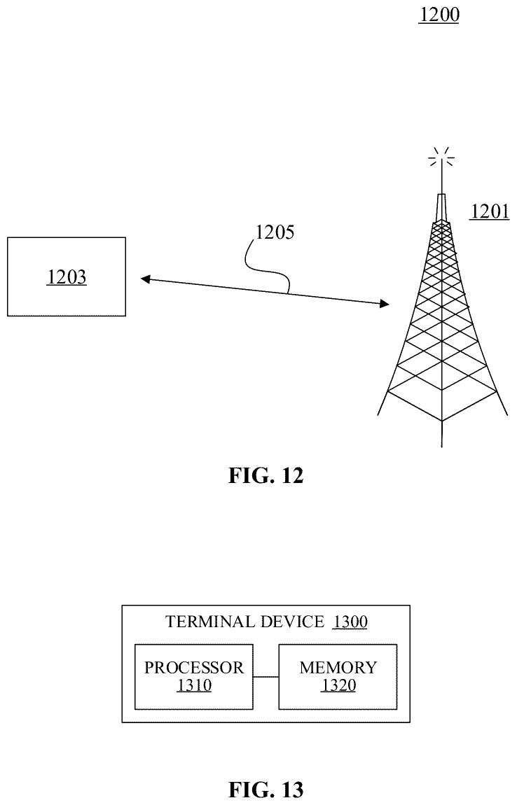

FIG. 12 is a schematic diagram of a wireless communication system 1200 in accordance with one or more implementations of the present disclosure. The wireless communication system 1200 can implement the DOVC frameworks discussed herein. As shown in FIG. 12, the wireless communications system 1200 can include a network device (or base station) 1201. Examples of the network device 101 include a base transceiver station (Base Transceiver Station, BTS), a NodeB (NodeB, NB), an evolved Node B (eNB or eNodeB), a Next Generation NodeB (gNB or gNode B), a Wireless Fidelity (Wi-Fi) access point (AP), etc. In some embodiments, the network device 1201 can include a relay station, an access point, an in-vehicle device, a wearable device, and the like. The network device 1201 can include wireless connection devices for communication networks such as: a Global System for Mobile Communications (GSM) network, a Code Division Multiple Access (CDMA) network, a Wideband CDMA (WCDMA) network, an LTE network, a cloud radio access network (Cloud Radio Access Network, CRAN), an Institute of Electrical and Electronics Engineers (IEEE) 802.11-based network (e.g., a Wi-Fi network), an Internet of Things (IOT) network, a device-to-device (D2D) network, a next-generation network (e.g., a 5G network), a future evolved public land mobile network (Public Land Mobile Network, PLMN), or the like. A 5G system or network can be referred to as a new radio (New Radio, NR) system or network.

In FIG. 12, the wireless communications system 1200 also includes a terminal device 1203. The terminal device 1203 can be an end-user device configured to facilitate wireless communication. The terminal device 1203 can be configured to wirelessly connect to the network device 1201 (via, e.g., via a wireless channel 1205) according to one or more corresponding communication protocols/standards. The terminal device 1203 may be mobile or fixed. The terminal device 1203 can be a user equipment (UE), an access terminal, a user unit, a user station, a mobile site, a mobile station, a remote station, a remote terminal, a mobile device, a user terminal, a terminal, a wireless communications device, a user agent, or a user apparatus. Examples of the terminal device 103 include a modem, a cellular phone, a smartphone, a cordless phone, a Session Initiation Protocol (SIP) phone, a wireless local loop (WLL) station, a personal digital assistant (PDA), a handheld device having a wireless communication function, a computing device or another processing device connected to a wireless modem, an in-vehicle device, a wearable device, an Internet-of-Things (IOT) device, a device used in a 5G network, a device used in a public land mobile network, or the like. For illustrative purposes, FIG. 12 illustrates only one network device 1201 and one terminal device 1203 in the wireless communications system 100. However, in some instances, the wireless communications system 1200 can include additional network device 1201 and/or terminal device 1203.

FIG. 13 is a schematic block diagram of a terminal device 1300 (e.g., which can implement the methods discussed herein) in accordance with one or more implementations of the present disclosure. As shown, the terminal device 1300 includes a processing unit 1310 (e.g., a DSP, a CPU, a GPU, etc.) and a memory 1320. The processing unit 1310 can be configured to implement instructions that correspond to the method 1100 of FIG. 11 and/or other aspects of the implementations described above. It should be understood that the processor in the implementations of this technology may be an integrated circuit chip and has a signal processing capability. During implementation, the steps in the foregoing method may be implemented by using an integrated logic circuit of hardware in the processor or an instruction in the form of software. The processor may be a general-purpose processor, a digital signal processor (DSP), an application specific integrated circuit (ASIC), a field programmable gate array (FPGA) or another programmable logic device, a discrete gate or transistor logic device, and a discrete hardware component. The methods, steps, and logic block diagrams disclosed in the implementations of this technology may be implemented or performed. The general-purpose processor may be a microprocessor, or the processor may be alternatively any conventional processor or the like. The steps in the methods disclosed with reference to the implementations of this technology may be directly performed or completed by a decoding processor implemented as hardware or performed or completed by using a combination of hardware and software modules in a decoding processor. The software module may be located at a random-access memory, a flash memory, a read-only memory, a programmable read-only memory or an electrically erasable programmable memory, a register, or another mature storage medium in this field. The storage medium is located at a memory, and the processor reads information in the memory and completes the steps in the foregoing methods in combination with the hardware thereof.

It may be understood that the memory in the implementations of this technology may be a volatile memory or a non-volatile memory, or may include both a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM) or a flash memory. The volatile memory may be a random-access memory (RAM) and is used as an external cache. For exemplary rather than limitative description, many forms of RAMs can be used, and are, for example, a static random-access memory (SRAM), a dynamic random-access memory (DRAM), a synchronous dynamic random-access memory (SDRAM), a double data rate synchronous dynamic random-access memory (DDR SDRAM), an enhanced synchronous dynamic random-access memory (ESDRAM), a synchronous link dynamic random-access memory (SLDRAM), and a direct Rambus random-access memory (DR RAM). It should be noted that the memories in the systems and methods described herein are intended to include, but are not limited to, these memories and memories of any other suitable type.

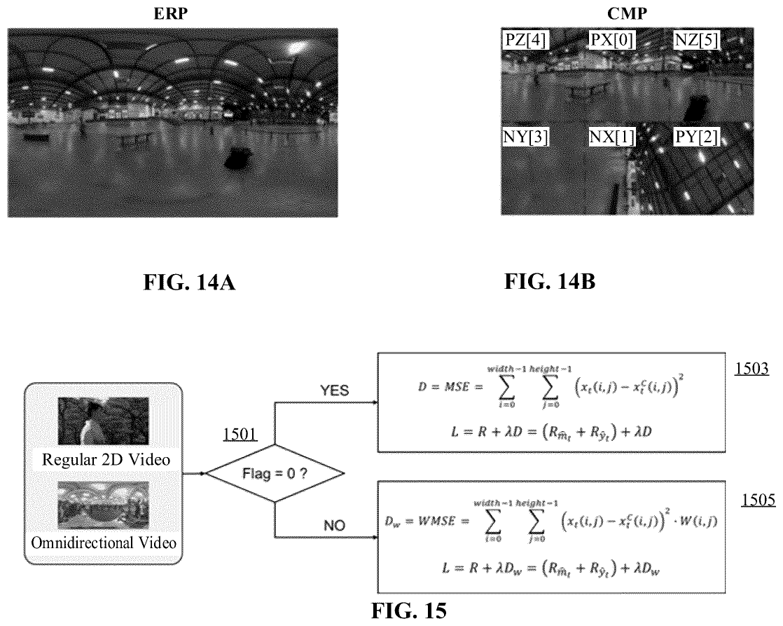

FIGS. 14A and 14B are images illustrating equirectangular projection (ERP) and cubemap projection (CMP) projection formats in accordance with one or more implementations of the present disclosure. The ERP and CMP can be used to process omnidirectional video sequences (e.g., by the projection module 305 in FIG. 3). In other embodiments, other suitable projection formats can also be utilized, such Octahedron Projection (OHP), Icosahedron Projection (ISP), etc. FIG. 14A shows a projected image based on ERP, whereas FIG. 14B shows a projected image based on CMP.

FIG. 15 is a schematic diagram illustrating a selection process of a loss function based on a flag in accordance with one or more implementations of the present disclosure. Please also refer to the descriptions for the video discriminator module 303 and the loss function module 327 in FIG. 3. At decision block 1501, an input video is examined and to see if there is a flag and a corresponding flag value. If the flag indicates “0,” Mean Squared Error (MSE) functions or Multi-scale Structural Similarity (MS-SSIM) functions can be used (1503). When the flag indicates “1,” weighted Mean Squared Error (WMSE) function can be used (1505).

As shown in FIG. 15, “D” represents the mean square error (MSE), and “Dw” represents the mean square error based on the weight (WMSE). The terms “width” and “height” are the width and height of the picture/frame, respectively. The terms “xₜ” and “xₜ^{C}” are the current frame and the reconstructed frame, respectively. “R_{\hat{m}}_{ₜ}” and “R_{ŷ}_{ₜ}” are the number of bits allocated for the latent representation of motion information and residual information, respectively. “W” is the distortion weight and can be shown as the equation below:

$$W = \frac{w ( i , j )}{{\sum }_{i = 0}^{w i d t h - 1} {\sum }_{j = 0}^{h e i g h t - 1} w ( i , j )}$$

The term “w(i,j)” is a weight factor of ERP or CMP.

FIGS. 16A and 16B are charts showing performance comparison of 360-degree videos projected to CMP and ERP formats. Four compression scheme VVC, DOVC (the present disclosure), HEVC, and DVC are analyzed and compared. “WS-PSNR” is a metric to evaluate the difference (quality) between two video clips in spherical domain. The term “Bpp” stands for “bits per pixel” which refers the total number of bits required to code the color information of the pixel. As shown in FIGS. 16A and 16B, the DOVC scheme provides higher quality than the HEVC and DVC schemes.

Also, the DOVC scheme can provide quality similar to the VVC scheme (but with less computing resources, due to the bi-directional prediction structure). “Table A” below shows a comparison of computing resource consumption by different schemes. “Class” and “Sequence Name” represent different testing samples. “Coding Time Complexity Comparison” shows time (in seconds) consumed for the coding. As shown, the VVC scheme (average “260279.819”) requires much higher computing resources (e.g., higher coding time) than the DOVC scheme (average “1650.327”).

TABLE A

| | | Coding Time Complexity Comparison (s) | | |
|---|---|---|---|---|
| Class | Sequence Name | VVC | HEVC | DOVC |
| S1 | ChairliftRide | 238798.367 | 84503.725 | 1512.226 |
| | Gaslamp | 70911.438 | 32773.284 | 1475.378 |
| | Harbor | 133933.894 | 48565.107 | 1522.904 |
| | KiteFlite | 363812.892 | 104027.615 | 1506.412 |
| | SkateboardInLot | 183657.670 | 65565.102 | 1460.329 |
| | Trolley | 90323.569 | 41697.319 | 1494.871 |
| S2 | Balboa | 629755.557 | 112035.185 | 1456.837 |
| | BranCastle2 | 162387.403 | 52067.384 | 1488.358 |
| | Broadway | 639893.832 | 124027.615 | 3117.108 |
| | Landings2 | 89323.569 | 41565.107 | 1468.843 |

| | | | |
|---|---|---|---|
| Average | 260279.819 | 70682.744 | 1650.327 |

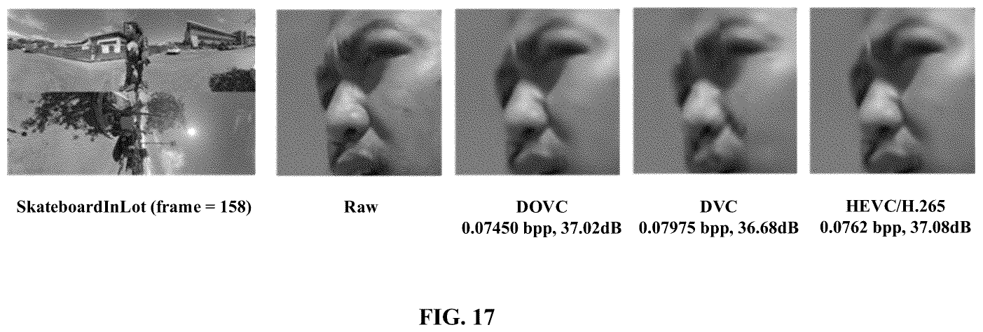

FIG. 17 includes images illustrating visual comparison among different methods. In FIG. 17, comparted to RAW image, the image generated based on the DOVC scheme provides higher quality than the images generated based on the HEVC and DVC schemes.

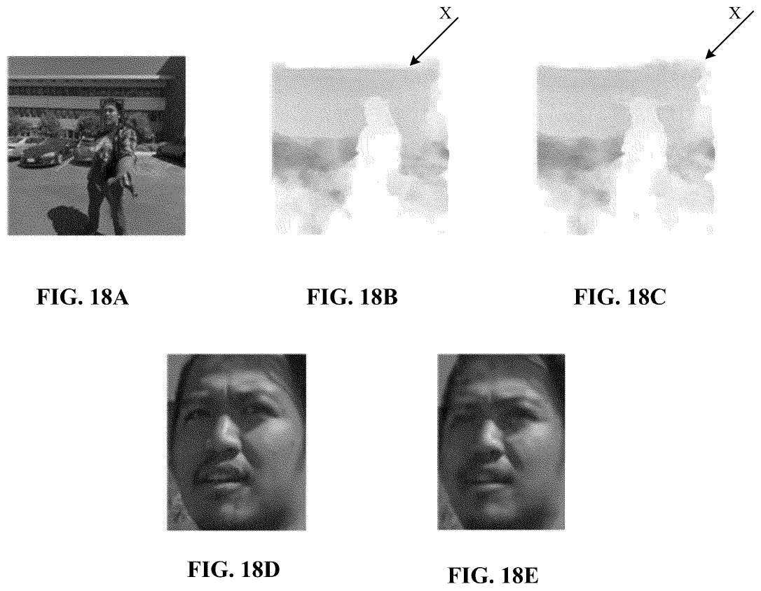

FIGS. 18A-E include images illustrating visual comparison among different methods. FIG. 18A shows a raw frame image. FIG. 18B shows a fused offset prediction map (DOVC) image. FIG. 18C shows an optical flow map image. FIG. 18D shows a bi-directional compensation (DOVC) image. FIG. 18E shows an uni-directional compensation (optical flow) image.

Comparing FIGS. 18B and 18C, the prediction map generated based on the DOVC scheme (FIG. 18B) can better predict the raw picture (FIG. 18A) than the prediction map generated based on the optical flow scheme (FIG. 18C). More particularly, the upper-right corner (indicated by arrow X) of the map of FIG. 18 matches better with the raw picture.

Comparing FIGS. 18D and 18E, the image generated based on the DOVC scheme (FIG. 18D) provides higher quality than the image generated based on the optical flow scheme (FIG. 18E).

FIG. 19 is a chart illustrating analyses on a quality enhance (QE) module in accordance with one or more implementations of the present disclosure. With a QE module, the DOVC scheme can provide better image quality than without the QE module.

### Additional Embodiments

According to at least some embodiments of the disclosure, a method for video processing is provided, which includes the following operations.

A current picture (xₜ) of the video is received.

A group of pictures (GOP) associated with the current picture (xₜ) is determined, the GOP includes a first key picture (xₛ^{I}) and a second key picture (xₑ^{I}), the first key picture is at a first time prior to the current picture (xₜ), and the second key picture is at a second time later than the current picture (xₜ).

A first reference picture based on the first key picture (xₛ^{I}) is generated.

A second reference picture based on the second key picture (xₑ^{I}) is generated.

Bi-directional predictive pictures (B/P pictures) in the GOP are determined based on the first reference picture and the second reference picture; and

A motion estimation (ME) process is performed based on the current picture (xₜ) and the bi-directional predictive pictures so as to generate motion information (vₜ) of the current picture (xₜ).

According to at least some embodiments, the method further includes: transmitting information of the first key picture and the second key picture in a bitstream.

According to at least some embodiments, the first reference picture is a first reconstructed picture (xₛ^{C}) based on the first key picture (xₛ^{I}) processed by a better portable graphics (BPG) image compression tool; and the second reference picture is a second reconstructed picture (xₑ^{C}) based on the second key picture (xₑ^{I}) processed by the BPG image compression tool.

According to at least some embodiments, the method further includes: encoding the motion information (vₜ) by a motion vector (MV) encoder so as to form a latent motion feature (mₜ) of the current picture (xₜ).

According to at least some embodiments, the method further includes: quantizing the latent motion feature (mₜ) to form a quantized motion feature (\hat{m}ₜ).

According to at least some embodiments, the method further includes: transmitting the quantized motion feature (\hat{m}ₜ) in a bitstream.

According to at least some embodiments, the method further includes: decoding the quantized motion feature (\hat{m}ₜ) to form motion information (\hat{v}ₜ) by an MV decoder; and performing a motion compensation (MC) process based on the predicted motion information (\hat{v}ₜ) and the bi-directional predictive pictures to form a predicted picture (\tilde{x}ₜ).

According to at least some embodiments, the method further includes: determining current residual information (rₜ) by comparing the predicted picture (\tilde{x}ₜ) and the current picture (xₜ).

According to at least some embodiments, the method further includes: encoding the current residual information (rₜ) by a residual encoder to form a latent residual feature (yₜ); quantizing the latent residual feature (yₜ) to form a quantized residual feature (ŷₜ); and transmitting the quantized residual feature (ŷₜ) in a bitstream.

According to at least some embodiments, the method further includes: decoding the quantized residual feature (ŷₜ) by a residual decoder to form residual information (yₜ); and generating a reconstructed picture (xₜ^{C}) based on the predicted picture (ŷₜ) and the predicted residual information (ŷₜ).

According to at least some embodiments, the method further includes: setting the reconstructed picture (xₜ^{C}) as the first or second reference picture.

According to at least some embodiments, the method further includes: determining, by a video discriminator module, whether the video includes an omnidirectional video sequence; and setting a value of a flag for the current picture based on the determination.

According to at least some embodiments, the method further includes: in response to an event that video includes the omnidirectional video sequence, performing a sphere-to-plane projection on the omnidirectional sequence.

According to at least some embodiments, the method further includes: determining a loss function based on a result of the determination of the video discriminator module, a type of the video, or a flag according to the result of the determination of the video discriminator module.

According to at least some embodiments, the ME process is performed by an offset prediction network, the offset prediction network is configured to perform an offset prediction based on offset values (δ) of the current picture (xₜ), the first reference picture, and the second reference picture.

According to at least some embodiments, the offset values (δ) are used to generate a feature map of the current picture (xₜ) by a spatiotemporal deformable convolution process.

According to at least some embodiments, the feature map is used to form a residual map of the current picture (xₜ) by a quality enhancement module, and wherein the quality enhancement module includes multiple convolutional layers (L), and wherein the quality enhancement module performs a rectified linear unit (ReLU) activation process so as to form the residual map.

According to at least some embodiments, the residual map is used to enhance a reconstructed picture (xₜ^{C}) generated based on the current picture (xₜ).

According to at least some embodiments, the offset values (δ) are used to generate a feature map of the current picture (xₜ), and wherein the feature map is used to form a residual map of the current picture (xₜ) by a quality enhancement module, and wherein the quality enhancement module includes multiple convolutional layers (L), and wherein the quality enhancement module performs a rectified linear unit (ReLU) activation process so as to form the residual map.

According to at least some embodiments of the disclosure, an encoder for video processing is provided, which includes a processor and a memory.

The memory is configured to store instructions, when executed by the processor, to: receive a current picture (xₜ) of a video; determine a group of pictures (GOP) associated with the current picture (xₜ), the GOP including a first key picture (xₛ^{I}) and a second key picture (xₑ^{I}), the first key picture being at a first time prior to the current picture (xₜ), the second key picture being at a second time later than the current picture (xₜ); generate a first reference picture based on the first key picture (xₛ^{I}); generate a second reference picture based on the second key picture (xₑ^{I}); determine bi-directional predictive pictures (B/P pictures) in the GOP based on the first reference picture and the second reference picture; and perform a motion estimation (ME) process based on the current picture (xₜ). and the bi-directional predictive pictures so as to generate motion information (vₜ) of the current picture (xₜ).

According to at least some embodiments, the instructions are further to: determine, by a video discriminator module of the encoder, whether the video includes an omnidirectional video sequence; and setting a value of a flag for the current picture based on the determination; and in response to an event that video includes the omnidirectional video sequence, perform a sphere-to-plane projection on the omnidirectional sequence, wherein the sphere-to-plane projection includes an equirectangular projection (ERP) or a cube-map projection (CMP).

According to at least some embodiments, the ME process is performed by an offset prediction network, the offset prediction network is configured to perform an offset prediction based on offset values (δ) of the current picture (xₑ^{I}), the first reference picture, and the second reference picture.

According to at least some embodiments of the disclosure, a method for video processing is provided, which includes following operations.

A current picture (xₜ) of the video is received.

It is determined whether the video includes an omnidirectional video sequence.

In response to an event that video includes the omnidirectional video sequence, a sphere-to-plane projection is performed on the omnidirectional sequence.

A group of pictures (GOP) associated with the current picture (xₜ) is determined, the GOP includes a first key picture (xₛ^{I}) and a second key picture (xₑ^{I}), wherein the first key picture is at a first time prior to the current picture (xₜ), and the second key picture is at a second time later than the current picture (xₜ).

A first reference picture is generated based on the first key picture (xₛ^{I}).

A second reference picture is generated based on the second key picture (xₑ^{I}).

Bi-directional predictive pictures (B/P pictures) in the GOP are determined based on the first reference picture and the second reference picture.

A motion estimation (ME) process is performed based on the current picture (xₜ). and the bi-directional predictive pictures so as to generate motion information (vₜ) of the current picture (xₜ).

The motion information (vₜ) is encoded by a motion vector (MV) encoder so as to form a latent motion feature (mₜ) of the current picture (xₜ).

The latent motion feature (mₜ) is quantized to form a quantized motion feature (\hat{m}ₜ).

The quantized motion feature (\hat{m}ₜ) is decoded to form a motion information (\hat{v}ₜ) by an MV decoder.

A motion compensation (MC) process is performed based on the predicted motion information (\hat{v}ₜ) and the bi-directional predictive pictures to form a predicted picture (\tilde{x}ₜ).

A current residual information (rₜ) is determined by comparing the predicted picture (\tilde{x}ₜ) and the current picture (xₜ).

The current residual information (rₜ) is encoded by a residual encoder to form a latent residual feature (yₜ).

The latent residual feature (yₜ) is quantized to form a quantized residual feature (ŷₜ).

The quantized residual feature (ŷt) is decoded by a residual decoder to form a predicted residual information (\hat{r}ₜ).

A reconstructed picture (xₜ^{C}) is generated based on the predicted picture (\tilde{x}ₜ) and the residual information (\hat{r}ₜ).

According to at least some embodiments, a method for video processing is provided, which includes following operations.

A bitstream is parsed to obtain a quantized motion feature (\hat{m}ₜ), the quantized motion feature (\hat{m}ₜ) is formed from motion information (vₜ) of a current picture (xₜ), the motion information (vₜ) is determined based on bi-directional predictive pictures (B/P pictures) in a group of pictures (GOP) based on first and second reference pictures of the current picture (xₜ), the first reference picture is at a first time prior to the current picture (xₜ), and wherein the second reference picture is at a second time later than the current picture (xₜ).

The quantized motion feature (\hat{m}ₜ) is decoded to form a motion information (\hat{v}ₜ) by an MV decoder.

According to at least some embodiments, the method further includes: parsing information of key pictures from the bitstream to obtain the first and second reference pictures, and performing a motion compensation (MC) process based on the predicted motion information (\hat{v}ₜ), the first and second reference pictures, and the bi-directional predictive pictures to form a predicted picture (\tilde{x}ₜ).

According to at least some embodiments, the method further includes: parsing the bitstream to obtain a quantized residual feature (ŷₜ); decoding the quantized residual feature (ŷₜ) by a residual decoder to form a predicted residual information (\hat{r}ₜ); and generating a reconstructed picture (xₜ^{C}) based on the predicted picture (\tilde{x}ₜ) and the residual information (\hat{r}ₜ).

According to at least some embodiments, a decoder for video processing is provided, which includes a processor and a memory.

The memory is configured to store instructions, when executed by the processor, to: parse a bitstream to obtain a quantized motion feature (\hat{m}ₜ), the quantized motion feature (\hat{m}ₜ) is formed from motion information (vₜ) of a current picture (xₜ), the motion information (vₜ) is determined based on bi-directional predictive pictures (B/P pictures) in a group of pictures (GOP) based on first and second reference pictures of the current picture (xₜ), the first reference picture is at a first time prior to the current picture (xₜ), and the second reference picture is at a second time later than the current picture (xₜ); and decode the quantized motion feature (\hat{m}ₜ) to form a motion information (\hat{v}ₜ) by an MV decoder.

The above Detailed Description of examples of the disclosed technology is not intended to be exhaustive or to limit the disclosed technology to the precise form disclosed above. While specific examples for the disclosed technology are described above for illustrative purposes, various equivalent modifications are possible within the scope of the described technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative implementations or sub-combinations. Each of these processes or blocks may be implemented in a variety of different ways. Also, while processes or blocks are at times shown as being performed in series, these processes or blocks may instead be performed or implemented in parallel, or may be performed at different times. Further, any specific numbers noted herein are only examples; alternative implementations may employ differing values or ranges.

In the Detailed Description, numerous specific details are set forth to provide a thorough understanding of the presently described technology. In other implementations, the techniques introduced here can be practiced without these specific details. In other instances, well-known features, such as specific functions or routines, are not described in detail in order to avoid unnecessarily obscuring the present disclosure. References in this description to “an implementation/embodiment,” “one implementation/embodiment,” or the like mean that a particular feature, structure, material, or characteristic being described is included in at least one implementation of the described technology. Thus, the appearances of such phrases in this specification do not necessarily all refer to the same implementation/embodiment. On the other hand, such references are not necessarily mutually exclusive either. Furthermore, the particular features, structures, materials, or characteristics can be combined in any suitable manner in one or more implementations/embodiments. It is to be understood that the various implementations shown in the figures are merely illustrative representations and are not necessarily drawn to scale.

Several details describing structures or processes that are well-known and often associated with communications systems and subsystems, but that can unnecessarily obscure some significant aspects of the disclosed techniques, are not set forth herein for purposes of clarity. Moreover, although the following disclosure sets forth several implementations of different aspects of the present disclosure, several other implementations can have different configurations or different components than those described in this section. Accordingly, the disclosed techniques can have other implementations with additional elements or without several of the elements described below.

Many implementations or aspects of the technology described herein can take the form of computer- or processor-executable instructions, including routines executed by a programmable computer or processor. Those skilled in the relevant art will appreciate that the described techniques can be practiced on computer or processor systems other than those shown and described below. The techniques described herein can be implemented in a special-purpose computer or data processor that is specifically programmed, configured, or constructed to execute one or more of the computer-executable instructions described below. Accordingly, the terms “computer” and “processor” as generally used herein refer to any data processor. Information handled by these computers and processors can be presented at any suitable display medium. Instructions for executing computer- or processor-executable tasks can be stored in or on any suitable computer-readable medium, including hardware, firmware, or a combination of hardware and firmware. Instructions can be contained in any suitable memory device, including, for example, a flash drive and/or other suitable medium.

The term “and/or” in this specification is only an association relationship for describing the associated objects, and indicates that three relationships may exist, for example, A and/or B may indicate the following three cases: A exists separately, both A and B exist, and B exists separately.

These and other changes can be made to the disclosed technology in light of the above Detailed Description. While the Detailed Description describes certain examples of the disclosed technology, as well as the best mode contemplated, the disclosed technology can be practiced in many ways, no matter how detailed the above description appears in text. Details of the system may vary considerably in its specific implementation, while still being encompassed by the technology disclosed herein. As noted above, particular terminology used when describing certain features or aspects of the disclosed technology should not be taken to imply that the terminology is being redefined herein to be restricted to any specific characteristics, features, or aspects of the disclosed technology with which that terminology is associated. Accordingly, the invention is not limited, except as by the appended claims. In general, the terms used in the following claims should not be construed to limit the disclosed technology to the specific examples disclosed in the specification, unless the above Detailed Description section explicitly defines such terms.

A person of ordinary skill in the art may be aware that, in combination with the examples described in the implementations disclosed in this specification, units and algorithm steps may be implemented by electronic hardware, or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

Although certain aspects of the invention are presented below in certain claim forms, the applicant contemplates the various aspects of the invention in any number of claim forms. Accordingly, the applicant reserves the right to pursue additional claims after filing this application to pursue such additional claim forms, in either this application or in a continuing application.

I/We claim:

1. A method for video processing, comprising:
receiving a current picture (xₜ);
determining a group of pictures (GOP) associated with the current picture (xₜ), wherein the GOP includes a first key picture (xₛ^{I}) and a second key picture (xₑ^{I}), wherein the first key picture is at a first time prior to the current picture (xₜ), and wherein the second key picture is at a second time later than the current picture (xₜ);
generating a first reference picture based on the first key picture (xₛ^{I});
generating a second reference picture based on the second key picture (xₑ^{I});
determining bi-directional predictive pictures (B/P pictures) in the GOP based on the first reference picture and the second reference picture; and
performing a motion estimation (ME) process based on the current picture (xₜ) and the bi-directional predictive pictures so as to generate motion information (vₜ) of the current picture (xₜ).

2. The method of claim 1, further comprising:
transmitting information of the first key picture and the second key picture in a bitstream.

3. The method of claim 1, further comprising:
encoding the motion information (vₜ) by a motion vector (MV) encoder so as to generate a latent motion feature (mₜ) of the current picture (xₜ).

4. The method of claim 3, further comprising quantizing the latent motion feature (mₜ) to generate a quantized motion feature (\hat{m}ₜ),
wherein the method further comprises transmitting the quantized motion feature (\hat{m}ₜ) in a bitstream.

5. The method of claim 4, further comprising:
decoding the quantized motion feature (\hat{m}ₜ) to generate a motion information (\hat{v}ₜ) by an MV decoder; and
performing a motion compensation (MC) process based on the motion information (\hat{v}ₜ) and the bi-directional predictive pictures to generate a predicted picture (\tilde{x}ₜ).

6. The method of claim 5, further comprising:
determining a residual information (rₜ) by comparing the predicted picture (\acute{x}ₜ) and the current picture (xₜ),
wherein the method further comprises:
encoding the residual information (rₜ) by a residual encoder to generate a latent residual feature (yₜ);
quantizing the latent residual feature (yₜ) to generate a quantized residual feature (ŷₜ); and
transmitting the quantized residual feature (ŷₜ) in a bitstream.

7. The method of claim 6, further comprising:
decoding the quantized residual feature (ŷₜ) by a residual decoder to generate residual information (\hat{r}ₜ); and
generating a reconstructed picture (\hat{x}ₜ) based on the predicted picture (\tilde{x}ₜ) and the residual information (\hat{r}ₜ).

8. The method of claim 7, further comprising setting the reconstructed picture (\hat{x}ₜ) as the first or second reference picture.

9. The method of claim 1, further comprising:
determining, by a video discriminator module, whether the video includes an omnidirectional video sequence; and
setting a value of a flag for the current picture based on the determination,
wherein the method further comprises:
in response to an event that video includes the omnidirectional video sequence, performing a sphere-to-plane projection on the omnidirectional video sequence.

10. The method of claim 9, further comprising:
determining a loss function based on a result of the determination of the video discriminator module, a type of the video, or a flag according to the result of the determination of the video discriminator module.

11. The method of claim 1, wherein the ME process is performed by an offset prediction network, the offset prediction network is configured to perform an offset prediction based on offset values (δ) of the current picture (xₜ), the first reference picture, and the second reference picture.

12. The method of claim 11, wherein the offset values (δ) are used to generate a feature map of the current picture (xₜ) by a spatiotemporal deformable convolution process.

13. The method of claim 12, wherein the feature map is used to form a residual map of the current picture (xₜ) by a quality enhancement module, and wherein the quality enhancement module includes multiple convolutional layers (L), and wherein the quality enhancement module performs a rectified linear unit (ReLU) activation process so as to generate the residual map,
wherein the residual map is used to enhance a reconstructed picture (\hat{x}ₜ) generated based on the current picture (xₜ).

14. A method for video processing, comprising:
parsing a bitstream to obtain a quantized motion feature (\hat{m}ₜ), wherein the quantized motion feature (\hat{m}ₜ) is determined from motion information (vₜ) of a current picture (xₜ), wherein the motion information (vₜ) is determined based on bi-directional predictive pictures (B/P pictures) in a group of pictures (GOP), the B/P pictures are determined based on first and second reference pictures of the current picture (xₜ), wherein the first reference picture is at a first time prior to the current picture (xₜ), and wherein the second reference picture is at a second time later than the current picture (xₜ); and
decoding the quantized motion feature (\hat{m}ₜ) to generate a motion information (\hat{v}ₜ) by an MV decoder.

15. The method of claim 14, further comprising:
parsing information of key pictures from the bitstream to obtain the first and second reference pictures; and
performing a motion compensation (MC) process based on the motion information (\hat{v}ₜ), the first and second reference pictures, and the bi-directional predictive pictures to generate a predicted picture (\tilde{x}ₜ).

16. The method of claim 15, further comprising:
parsing the bitstream to obtain a quantized residual feature (ŷₜ);
decoding the quantized residual feature (\hat{r}ₜ) by a residual decoder to generate a residual information (\hat{r}ₜ); and
generating a reconstructed picture (\hat{x}ₜ) based on the predicted picture (\tilde{x}ₜ) and the residual information (\hat{r}ₜ).

17. The method of claim 15, further comprising:
performing convolutional process on the reconstructed picture (\hat{x}ₜ) for quality enhancement.

18. A decoder for video processing, comprising:
a processor;
a memory configured to store instructions, when executed by the processor, to:
parse a bitstream to obtain a quantized motion feature (\hat{m}ₜ), wherein the quantized motion feature (\hat{m}ₜ) is formed from motion information (vₜ) of a current picture (xₜ), wherein the motion information (vₜ) is determined based on bi-directional predictive pictures (B/P pictures) in a group of pictures (GOP), the B/P pictures are determined based on first and second reference pictures of the current picture (xₜ), wherein the first reference picture is at a first time prior to the current picture (xₜ), and wherein the second reference picture is at a second time later than the current picture (xₜ); and
decode the quantized motion feature (\hat{m}ₜ) to generate a motion information (\hat{v}ₜ) by an MV decoder.

19. The decoder of claim 18, wherein the instructions are further to:
parse information of key pictures from the bitstream to obtain the first and second reference pictures; and
perform a motion compensation (MC) process based on the motion information (\hat{v}ₜ), the first and second reference pictures, and the bi-directional predictive pictures to generate a predicted picture (\acute{x}ₜ).

20. The decoder of claim 19, wherein the instructions are further to:
parse the bitstream to obtain a quantized residual feature (ŷₜ);
decode the quantized residual feature (ŷₜ) by a residual decoder to generate residual information (\hat{r}ₜ); and
generate a reconstructed picture (xₜ^{C}) based on the predicted picture (\tilde{x}ₜ) and the residual information (\hat{r}ₜ).
